(19) United States
(12) Patent Application Publication
(10) Pub. No.: US 2014/0306931 A1
(43) Pub. Date: Oct. 16, 2014

(54) OPTICAL TOUCH SYSTEM AND TOUCH METHOD THEREOF

(71) Applicant: WISTRON CORPORATION, New Taipei City (TW)

(72) Inventors: Shou-Te Wei, New Taipei City (TW); Chia-Chang Hou, New Taipei City (TW); Hsun-Hao Chang, New Taipei City (TW); Shang-Chin Su, New Taipei City (TW)

(73) Assignee: Wistron Corporation, New Taipei City (TW)

(21) Appl. No.: 13/891,203

(22) Filed: May 10, 2013

(30) Foreign Application Priority Data
Apr. 16, 2013 (TW) 102113526

(51) Int. Cl. G06F 3/042; G06F 3/0354

(52) U.S. Cl. CPC G06F 3/0428; G06F 3/03545
USPC 345/175

(57) ABSTRACT

An optical touch system includes a touch plane; a handheld object including a light emitting unit for emitting a light to the touch plane; two image sensing units disposed at two corners of the touch plane, respectively, and used for receiving the light; and a processing unit electrically connected to the two image sensing units and used for analyzing a light characteristic of the light and executing an operation function according to the light characteristic.

### BACKGROUND OF THE INVENTION

1. Field of the Invention

The invention relates to an optical touch system and a touch method thereof and, more particularly, to an optical touch system and a touch method thereof allowing a user to operate a handheld object to emit light to a touch plane and then utilizing light characteristics of the light to execute an operation function correspondingly.

2. Description of the Prior Art

With development of touch technology, in various kinds of consumer electronic products (e.g. display device, all-in-one device, mobile phone, personal digital assistant (PDA), flat computer, etc.), a touch device has become a main tool for data input. Compared with other touch design, such as a resistive touch design, a capacitive touch design, an ultrasonic touch design, or a projective touch design, an optical touch design has lower cost and is easier to use, especially for large-size touch display.

However, the touch function is very inconvenient for a multi-layer user interface. In general, the multi-layer user interface shows some major options first (e.g. file, edit, view, etc.) and each of the major options further has a plurality of minor options (e.g. cut, paste, copy, undo, etc.). When a user uses his/her finger or a stylus to click one of the major or minor options in the multi-layer user interface, other functions may be executed by a mistake due to the size of the finger or stylus, so that the operation performance of the prior art is really bad.

### SUMMARY OF THE INVENTION

The invention provides an optical touch system and a touch method thereof allowing a user to operate a handheld object to emit light to a touch plane and then utilizing light characteristics of the light to execute an operation function correspondingly, so as to solve the aforesaid problems.

According to the claimed invention, an optical touch system comprises a touch plane; a handheld object comprising a light emitting unit for emitting a light to the touch plane; two image sensing units disposed at two corners of the touch plane, respectively, and used for receiving the light; and a processing unit electrically connected to the two image sensing units and used for analyzing a light characteristic of the light and executing an operation function according to the light characteristic.

According to the claimed invention, the optical touch system further comprises a memory unit electrically connected to the processing unit and used for storing a plurality of predetermined light characteristics and a plurality of predetermined operation functions, each of the predetermined light characteristics is corresponding to one of the predetermined operation functions, the processing unit compares the light characteristic with the predetermined light characteristics, so as to select the operation function from the predetermined operation functions.

According to the claimed invention, the light characteristic comprises at least one of a light intensity and a light twinkling frequency.

According to the claimed invention, the optical touch system further comprises a frame disposed at a periphery of the touch plane, a distance between the light emitting unit and the touch plane is smaller than or equal to a height of the frame.

According to the claimed invention, the handheld object further comprises a switch electrically connected to the light emitting unit and used for controlling the light emitting unit to emit the light, so as to generate the light characteristic.

According to the claimed invention, an optical touch system comprises a touch plane; two image sensing units disposed at two corners of the touch plane, respectively, and used for receiving a light over the touch plane; and a processing unit electrically connected to the two image sensing units and used for analyzing a light twinkling frequency of the light and executing an operation function according to the light twinkling frequency.

According to the claimed invention, the optical touch system further comprises a memory unit electrically connected to the processing unit and used for storing a plurality of predetermined light twinkling frequencies and a plurality of predetermined operation functions, each of the predetermined light twinkling frequencies is corresponding to one of the predetermined operation functions, the processing unit compares the light twinkling frequency with the predetermined light twinkling frequencies, so as to select the operation function from the predetermined operation functions.

According to the claimed invention, the optical touch system further comprises a handheld object comprising a light emitting unit for emitting the light to the touch plane.

According to the claimed invention, the optical touch system further comprises a frame disposed at a periphery of the touch plane, a distance between the light emitting unit and the touch plane is smaller than or equal to a height of the frame.

According to the claimed invention, the handheld object further comprises a switch electrically connected to the light emitting unit and used for controlling the light emitting unit to emit the light, so as to generate the light twinkling frequency.

According to the claimed invention, a touch method comprises steps of receiving a light over a touch plane; analyzing a light twinkling frequency of the light; and executing an operation function according to the light twinkling frequency.

According to the claimed invention, the touch method further comprises steps of storing a plurality of predetermined light twinkling frequencies and a plurality of predetermined operation functions, wherein each of the predetermined light twinkling frequencies is corresponding to one of the predetermined operation functions; and comparing the light twinkling frequency with the predetermined light twinkling frequencies, so as to select the operation function from the predetermined operation functions.

According to the claimed invention, the touch method further comprises steps of moving a handheld object to the touch plane, wherein the handheld object comprises a light emitting unit; and controlling the light emitting unit to emit the light to the touch plane.

According to the claimed invention, a frame is disposed at a periphery of the touch plane, the touch method further comprises step of shortening a distance between the light emitting unit and the touch plane to be smaller than or equal to a height of the frame.

As mentioned in the above, in the beginning, a user can move the handheld object (e.g. stylus) to the touch plane and then control the light emitting unit of the handheld object to emit light to the touch plane. After the image sensing units receives the light emitted by the light emitting unit of the handheld object, the processing unit analyzes the light characteristic (e.g. light intensity and/or light twinkling frequency) of the light and then executes the operation function (e.g. cut, paste, copy, undo, etc.) according to the light characteristic correspondingly. In other words, the invention utilizes the light characteristic of the light emitted by the light emitting unit of the handheld object instead of the conventional touch manner to execute the corresponding operation function. Accordingly, the user can execute the desired function precisely without mis-operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an optical touch system according to an embodiment of the invention.

FIG. 2 is a functional block diagram illustrating the optical touch system shown in FIG. 1.

FIG. 3 is a cross-sectional view illustrating the optical touch system along a line A-A shown in FIG. 1.

FIG. 4 is a flowchart illustrating a touch method according to an embodiment of the invention.

FIG. 5 is a schematic diagram illustrating a handheld object according to another embodiment of the invention.

FIG. 6 is a schematic diagram illustrating a handheld object according to another embodiment of the invention.

### DETAILED DESCRIPTION

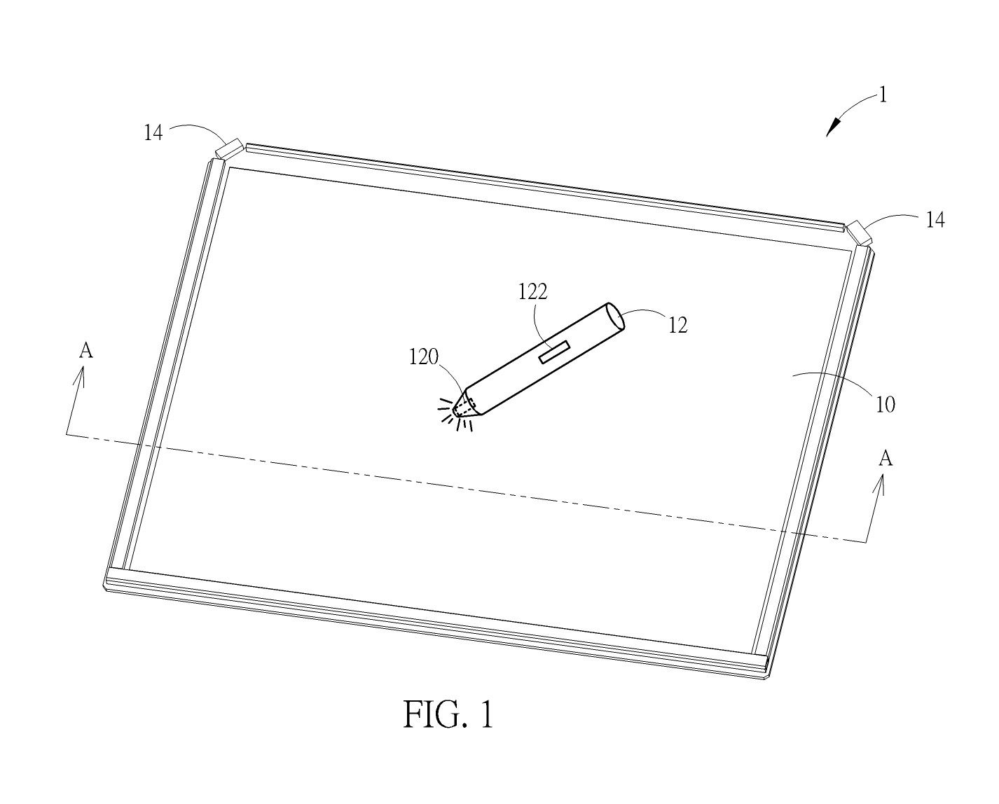

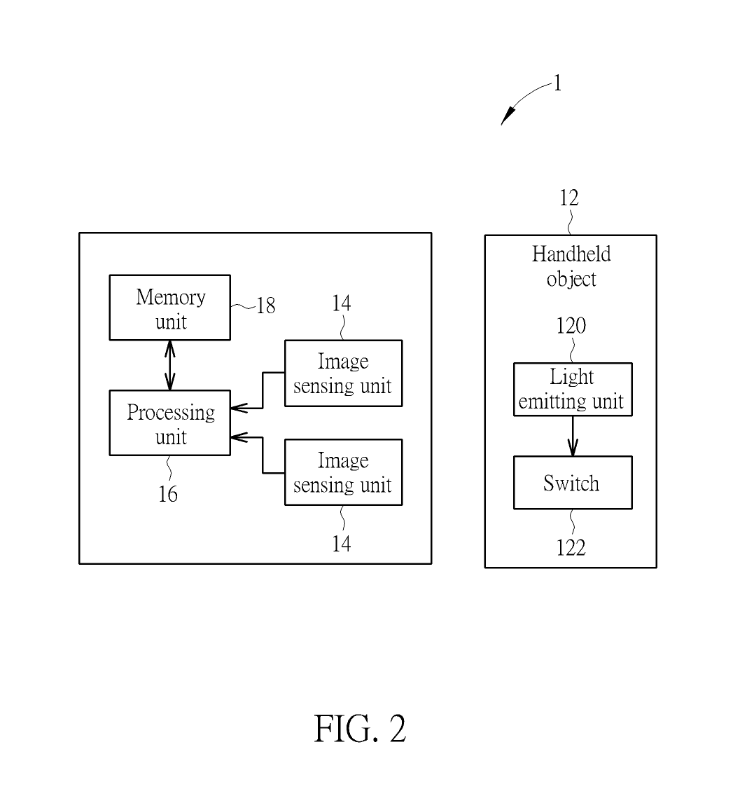

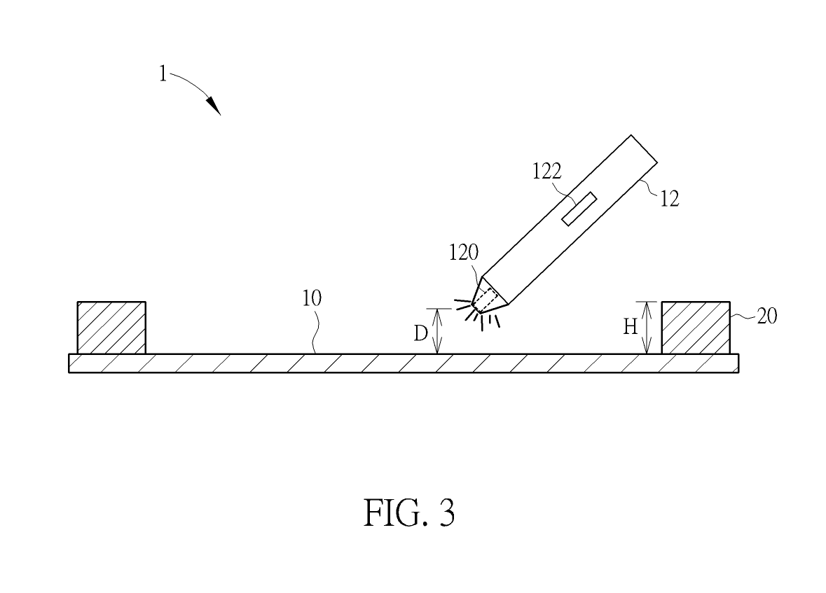

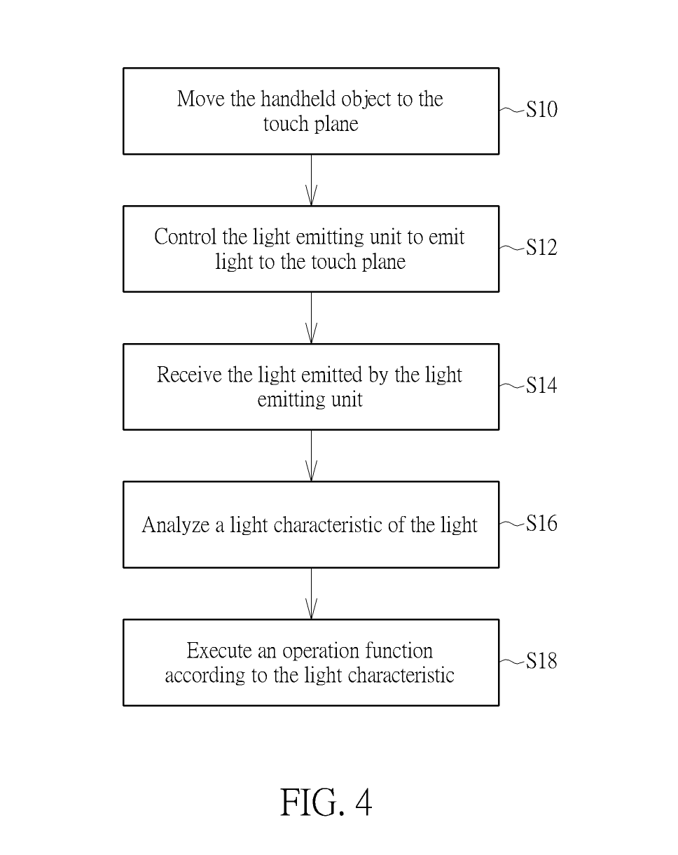

Referring to FIGS. 1 to 4, FIG. 1 is a schematic diagram illustrating an optical touch system 1 according to an embodiment of the invention, FIG. 2 is a functional block diagram illustrating the optical touch system 1 shown in FIG. 1, FIG. 3 is a cross-sectional view illustrating the optical touch system 1 along a line A-A shown in FIG. 1, and FIG. 4 is a flowchart illustrating a touch method according to an embodiment of the invention. The touch method shown in FIG. 4 can be implemented by the optical touch system 1 shown in FIGS. 1 and 2. Furthermore, the control logics of the touch method shown in FIG. 4 can be implemented by circuit and software design.

As shown in FIGS. 1 and 2, the optical touch system 1 comprises a touch plane 10, a handheld object 12, two image sensing units 14, a processing unit 16, a memory unit 18 and a frame 20. The frame 20 is disposed at a periphery of the touch plane 10. The two image sensing units 14 are disposed at two corners of one side of the touch plane 10, respectively. The processing unit 16 is electrically connected to the two image sensing units 14 and the memory unit 18. The memory unit 18 may be connected to the processing unit 16 externally or built in the processing unit 16 according to practical applications. The handheld object 12 comprises a light emitting unit 120 and a switch 122, wherein the switch 122 is electrically connected to the light emitting unit 120 and used for controlling the light emitting unit 120 to emit a light to the touch plane 10.

In practical applications, two light emitting units (e.g. light emitting diode) may be disposed beside the two image sensing units 14, respectively, or alternatively a light bar may be disposed on the frame 20, so as to provide sufficient light for common touch operation. When two light emitting units are disposed beside the two image sensing units 14, respectively, the frame 20 may absorb or reflect light according to practical applications. In this embodiment, the touch plane 10 may be a display panel (e.g. liquid crystal display panel), a white board, a black board or other planes; the handheld object 12 may be stylus; the image sensing unit 14 may be a charge-coupled device (CCD) sensor or a complementary metal-oxide semiconductor (CMOS) sensor; the processing unit 16 may be a processor or a controller with data calculation/processing function; the memory unit 18 may be a volatile memory or a non-volatile memory; and the light emitting unit 120 may be a light emitting diode.

The memory unit 18 is used for storing a plurality of predetermined light characteristics and a plurality of predetermined operation functions, and each of the predetermined light characteristics is corresponding to one of the predetermined operation functions, wherein the predetermined light characteristic comprises at least one of a light intensity and a light twinkling frequency. As shown in Tables 1 to 3 below, the predetermined light characteristic in Table 1 is represented by the light intensity, the predetermined light characteristic in Table 2 is represented by the light twinkling frequency, and the predetermined light characteristic in Table 3 is represented by a combination of the light intensity and the light twinkling frequency.

TABLE 1

| Predetermined light | Predetermined |
|---|---|
| characteristic (light | operation |
| intensity) | function |
| 100 cd-199 cd | Cut |
| 200 cd-299 cd | Copy |
| 300 cd-399 cd | Paste |
| . . . | . . . |
| 900 cd-999 cd | Undo |

TABLE 2

| Predetermined light | Predetermined |
|---|---|
| characteristic (light | operation |
| twinkling frequency) | function |
| 5 Hz | Cut |
| 10 Hz | Copy |
| 20 Hz | Paste |
| . . . | . . . |
| 100 Hz | Undo |

TABLE 3

| | |
|---|---|
| Predetermined light characteristic | Predetermined |

| | Light twinkling | operation |
|---|---|---|
| Light intensity | frequency | function |
| 100 cd-199 cd | 5 Hz | Cut |
| 200 cd-299 cd | 5 Hz | Copy |
| 200 cd-299 cd | 20 Hz | Paste |
| . . . | . . . | . . . |
| 900 cd-999 cd | 100 Hz | Undo |

It should be noted that though the light twinkling frequency in Tables 2 and 3 is a fixed frequency, the light twinkling frequency of the invention may also be a variable frequency, which increase or decreases gradually within a span of time. For example, the light twinkling frequency may increase from 5 Hz to 20 Hz gradually within five seconds or decrease from 10 Hz to 5 Hz gradually within three seconds. Furthermore, the relation and format of the predetermined light characteristic and the predetermined operation function in Tables 1 to 3 can be designed based on practical applications, so they are not limited to the aforesaid embodiments.

The invention allows a user to operate the handheld object 12 to emit light to the touch plane 10, so as to utilize the light characteristic (e.g. light intensity and/or light twinkling frequency) of the light to execute the operation function correspondingly. First of all, the user has to move the handheld object 12 to the touch plane 10 (step S10 shown in FIG. 4). Afterward, the user has to operate the switch 122 of the handheld object 12 to control the light emitting unit 120 to emit light to the touch plane 10 (step S12 shown in FIG. 4). In this embodiment, the switch 122 may be a button, so that the user can press the switch 122 to control the light emitting unit 120 to emit light with different light characteristics to the touch plane 10. For example, when the user presses the switch 122 once, the light emitting unit 120 may emit light with a light intensity of 150 cd and/or a light twinkling frequency of 5 Hz; when the user presses the switch 122 twice, the light emitting unit 120 may emit light with a light intensity of 250 cd and/or a light twinkling frequency of 10 Hz; when the user presses the switch 122 three times, the light emitting unit 120 may emit light with a light intensity of 350 cd and/or a light twinkling frequency of 20 Hz; and so on.

As shown in FIG. 3, when the user wants to utilize the light characteristic of the light emitted by the light emitting unit 120 of the handheld object 12 to execute the operation function correspondingly, he/she has to shorten a distance D between the light emitting unit 120 and the touch plane 10 to be smaller than or equal to a height H of the frame 20, so as to ensure that the two image sensing units 14 can receive sufficient light emitted by the light emitting unit 120.

Afterward, the two image sensing units 14 receive the light emitted by the light emitting unit 120 over the touch plane 10 (step S14 shown in FIG. 4). Then, the processing unit 16 analyzes a light characteristic of the light (step S16 shown in FIG. 4). Finally, the processing unit 16 executes an operation function according to the light characteristic (step S18 shown in FIG. 4). In this embodiment, the processing unit 16 compares the analyzed light characteristic with the predetermined light characteristics stored in the memory unit 18, so as to select the corresponding operation function from the predetermined operation functions stored in the memory unit 18. For example, as shown in Table 1, when the light characteristic analyzed by the processing unit 16 is a light intensity of 150 cd, the processing unit 16 executes an operation function of “cut” correspondingly; as shown in Table 2, when the light characteristic analyzed by the processing unit 16 is a light twinkling frequency of 10 Hz, the processing unit 16 executes an operation function of “copy” correspondingly; as shown in Table 3, when the light characteristic analyzed by the processing unit 16 is a combination of a light intensity of 250 cd and a light twinkling frequency of 20 Hz, the processing unit 16 executes an operation function of “paste” correspondingly; and so on.

It should be noted that the distance between the handheld object 12 and the image sensing unit 14 will influence the light intensity of the light received by the image sensing unit 14. When the handheld object 12 is close to the image sensing unit 14, the light intensity of the light received by the image sensing unit 14 is high. On the other hand, when the handheld object 12 is far away from the image sensing unit 14, the light intensity of the light received by the image sensing unit 14 is low. Therefore, the invention may store a plurality of light intensities corresponding to all positions on the touch plane 10 in the memory unit 18. For example, a light intensity X sensed at a position close to the image sensing unit 14 is used to execute an operation function Y, and another light intensity 0.8X sensed at another position far away from the image sensing unit 14 is also used to execute the operation function Y. Furthermore, the invention may also store a plurality of exposure intensities corresponding to all positions on the touch plane 10 in the memory unit 18. For example, when the handheld object 12 is far away from the image sensing unit 14, the invention raises the exposure intensity of the image sensing unit 14, so as to compensate the reduced light intensity due to the distance. In other words, the invention can change the exposure intensity of the image sensing unit 14 according to the distance between the handheld object 12 and the image sensing unit 14, so that the light intensity of the light received by the image sensing unit 14 at any position of the touch plane 10 will be kept the same.

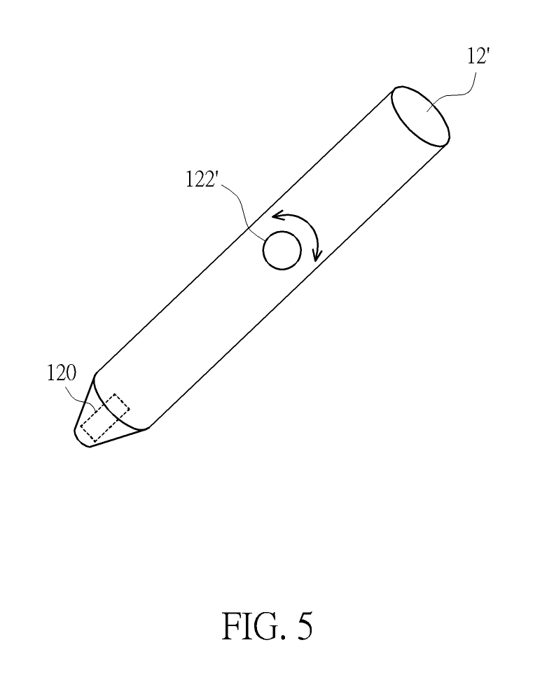

Referring to FIG. 5, FIG. 5 is a schematic diagram illustrating a handheld object 12′ according to another embodiment of the invention. The main difference between the handheld object 12′ and the aforesaid handheld object 12 is that the switch 122′ of the handheld object 12′ is a rotary button, so that the user can rotate the switch 122′ to control the light emitting unit 120 to emit light with different light characteristics to the touch plane 10.

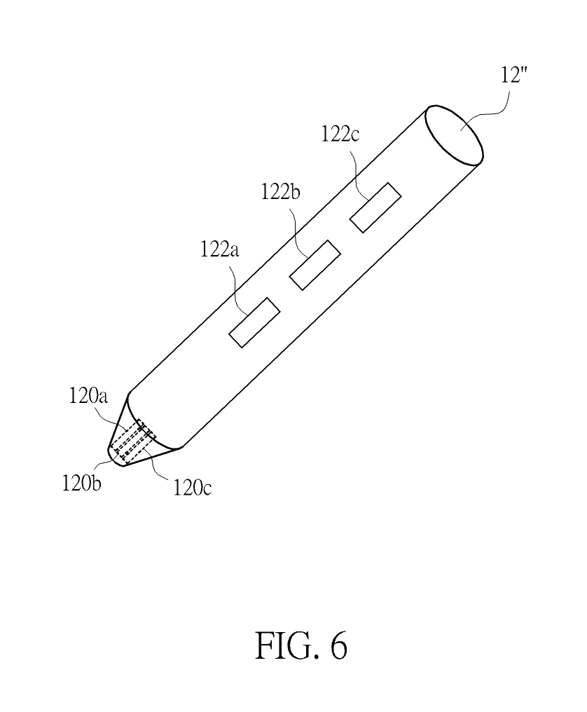

Referring to FIG. 6, FIG. 6 is a schematic diagram illustrating a handheld object 12″ according to another embodiment of the invention. The main difference between the handheld object 12″ and the aforesaid handheld object 12 is that the handheld object 12″ comprises a plurality of light emitting units 120a, 120b, 120c and a plurality of switches 122a, 122b, 122c, wherein each of the switches 122a, 122b, 122c is used for controlling one of the light emitting units 120a, 120b, 120c correspondingly to emit light with different light characteristics. For example, when the user presses the switch 122a, the light emitting unit 120a may emit light with a light intensity of 150 cd and/or a light twinkling frequency of 5 Hz; when the user presses the switch 122b, the light emitting unit 120b may emit light with a light intensity of 250 cd and/or a light twinkling frequency of 10 Hz; and when the user presses the switch 122c, the light emitting unit 120c may emit light with a light intensity of 350 cd and/or a light twinkling frequency of 20 Hz.

As mentioned in the above, in the beginning, a user can move the handheld object (e.g. stylus) to the touch plane and then control the light emitting unit of the handheld object to emit light to the touch plane. After the image sensing units receives the light emitted by the light emitting unit of the handheld object, the processing unit analyzes the light characteristic (e.g. light intensity and/or light twinkling frequency) of the light and then executes the operation function (e.g. cut, paste, copy, undo, etc.) according to the light characteristic correspondingly. In other words, the invention utilizes the light characteristic of the light emitted by the light emitting unit of the handheld object instead of the conventional touch manner to execute the corresponding operation function. Accordingly, the user can execute the desired function precisely without mis-operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical touch system comprising:
a touch plane;
a handheld object comprising a light emitting unit for emitting a light to the touch plane;
two image sensing units disposed at two corners of the touch plane, respectively, and used for receiving the light; and
a processing unit electrically connected to the two image sensing units and used for analyzing a light characteristic of the light and executing an operation function according to the light characteristic.

2. The optical touch system of claim 1, further comprising a memory unit electrically connected to the processing unit and used for storing a plurality of predetermined light characteristics and a plurality of predetermined operation functions, each of the predetermined light characteristics being corresponding to one of the predetermined operation functions, the processing unit comparing the light characteristic with the predetermined light characteristics, so as to select the operation function from the predetermined operation functions.

3. The optical touch system of claim 1, wherein the light characteristic comprises at least one of a light intensity and a light twinkling frequency.

4. The optical touch system of claim 1, further comprising a frame disposed at a periphery of the touch plane, a distance between the light emitting unit and the touch plane being smaller than or equal to a height of the frame.

5. The optical touch system of claim 1, wherein the handheld object further comprises a switch electrically connected to the light emitting unit and used for controlling the light emitting unit to emit the light, so as to generate the light characteristic.

6. An optical touch system comprising:
a touch plane;
two image sensing units disposed at two corners of the touch plane, respectively, and used for receiving a light over the touch plane; and
a processing unit electrically connected to the two image sensing units and used for analyzing a light twinkling frequency of the light and executing an operation function according to the light twinkling frequency.

7. The optical touch system of claim 6, further comprising a memory unit electrically connected to the processing unit and used for storing a plurality of predetermined light twinkling frequencies and a plurality of predetermined operation functions, each of the predetermined light twinkling frequencies being corresponding to one of the predetermined operation functions, the processing unit comparing the light twinkling frequency with the predetermined light twinkling frequencies, so as to select the operation function from the predetermined operation functions.

8. The optical touch system of claim 6, further comprising a handheld object comprising a light emitting unit for emitting the light to the touch plane.

9. The optical touch system of claim 8, further comprising a frame disposed at a periphery of the touch plane, a distance between the light emitting unit and the touch plane being smaller than or equal to a height of the frame.

10. The optical touch system of claim 8, wherein the handheld object further comprises a switch electrically connected to the light emitting unit and used for controlling the light emitting unit to emit the light, so as to generate the light twinkling frequency.

11. A touch method comprising:
receiving a light over a touch plane;
analyzing a light twinkling frequency of the light; and
executing an operation function according to the light twinkling frequency.

12. The touch method of claim 11, further comprising:
storing a plurality of predetermined light twinkling frequencies and a plurality of predetermined operation functions, wherein each of the predetermined light twinkling frequencies is corresponding to one of the predetermined operation functions; and
comparing the light twinkling frequency with the predetermined light twinkling frequencies, so as to select the operation function from the predetermined operation functions.

13. The touch method of claim 11, further comprising:
moving a handheld object to the touch plane, wherein the handheld object comprises a light emitting unit; and
controlling the light emitting unit to emit the light to the touch plane.

14. The touch method of claim 13, wherein a frame is disposed at a periphery of the touch plane, the touch method further comprises:
shortening a distance between the light emitting unit and the touch plane to be smaller than or equal to a height of the frame.
